(19) United States
(12) Patent Application Publication
(10) Pub. No.: US 2023/0058709 A1
(43) Pub. Date: Feb. 23, 2023

(54) AUTONOMOUS VEHICLE CONTROL DEVICE

(71) Applicant: TOYOTA JIDOSHA KABUSHIKI KAISHA, Aichi-ken (JP)

(72) Inventor: Shuichi ASO, Toyota-shi (JP)

(21) Appl. No.: 17/878,911

(22) Filed: Aug. 2, 2022

(30) Foreign Application Priority Data
Aug. 23, 2021 (JP) 2021-135393

(51) Int. Cl. B60Q 11/00; B60W 60/00; B60W 50/02; B60W 50/14

(52) U.S. Cl. CPC B60Q 11/00; B60W 50/14; B60W 50/0205; B60W 60/005; B60W 2050/143; B60W 2554/80; B60W 2756/10; H04W 4/40

(57) ABSTRACT

An autonomous vehicle control device controls an autonomous vehicle provided with a warning sound output device. The autonomous vehicle control device prohibits transition to a traveling mode when an abnormality occurs in the warning sound output device. Before traveling, the autonomous vehicle control device may execute sound output control to cause the warning sound output device to output a warning sound, and determine whether the abnormality occurs based on output data of the warning sound output by the warning sound output device.

### CROSS-REFERENCE TO RELATED APPLICATION

This application claims priority to Japanese Patent Application No. 2021-135393 filed on Aug. 23, 2021, incorporated herein by reference in its entirety.

### BACKGROUND

### 1. Technical Field

The present disclosure relates to an autonomous vehicle control device.

### 2. Description of Related Art

In the related art, as an autonomous vehicle, there is one described in Japanese Unexamined Patent Application Publication No. 2019-182120 (JP 2019-182120A ). The autonomous vehicle requests an output of a warning sound to surrounding vehicles when an abnormality occurs in a warning sound output device, requests replacement of the leading vehicle, or prohibits autonomous driving when a driver is on board.

### SUMMARY

The above-mentioned autonomous vehicle travels normally even when an abnormality occurs in the warning sound output device. Therefore, this may cause occupants and pedestrians to feel anxiety. Therefore, an object of the present disclosure is to provide an autonomous vehicle control device that does not cause occupants and pedestrians to feel anxiety when an abnormality occurs in a warning sound output device.

In order to solve the above issue, an autonomous vehicle control device according to the present disclosure is an autonomous vehicle control device that controls an autonomous vehicle provided with a warning sound output device, and when an abnormality occurs in the warning sound output device, transition to a traveling mode is prohibited.

According to the present disclosure, it is possible to prohibit traveling of the autonomous vehicle when an abnormality occurs in the warning sound output device, whereby the occupants of the autonomous vehicle and the pedestrians are not caused to feel anxiety.

Further, in the present disclosure, before traveling, sound output control to cause the warning sound output device to output a warning sound may be executed, and whether the abnormality occurs may be determined based on output data of the warning sound output by the warning sound output device.

With the above configuration, the abnormality of the warning sound can be accurately determined. When the warning sound is not sounded, the output data is data indicating that the warning sound is not present.

Further, in the present disclosure, the autonomous vehicle includes a communication device for performing bidirectional wireless communication with an outside, and when the abnormality occurs, the communication device is caused to transmit a signal indicating the abnormality to a predetermined information terminal.

With the above configuration, it is possible to promptly notify a predetermined person, for example, the owner of the autonomous vehicle, of an abnormality in the warning sound output device, and it is easy to quickly repair the warning sound output device.

Further, in the present disclosure, a storage unit that stores information that realizes an allowable mode that allows the transition to the traveling mode only once may be provided, and after the signal is transmitted, when a signal for enabling the allowable mode is received from the information terminal via the communication device, the transition to the traveling mode may be allowed only once.

With this configuration, for example, it is possible to cause the autonomous vehicle to travel so as to be brought to a repair shop.

Further, in the present disclosure, when the transition to the traveling mode is allowed, at least one of traveling with a warning lamp turned on and traveling at a predetermined vehicle speed or less may be executed.

With this configuration, even when the warning sound output device does not operate normally, it is possible to realize at least one of capability to alert people in the vehicle and easiness to cause the autonomous vehicle to safely travel to the repair shop.

Further, in the present disclosure, the warning sound may be selected based on a position of the autonomous vehicle specified using a global positioning system.

The warning sound that is output needs to comply with the laws and regulations of the country or region where the autonomous vehicle is located. In addition, the sound recognized as a warning sound differs depending on the country or region concerned.

With the above configuration, the warning sound can be automatically changed so as to comply with the laws and regulations of the country or region where the autonomous vehicle is located. Therefore, it is not necessary to artificially change the warning sound, and therefore the autonomous vehicle can be used all over the world, whereby the autonomous vehicle having excellent versatility and convenience can be realized. In addition, it is possible to output the warning sound that are suitable for the customs of the country or region where the autonomous vehicle is located, and no matter which country or region the autonomous vehicle is used in, the autonomous vehicle can output a sound that is easy for people in that country or region to recognize as a warning sound.

Further, the autonomous vehicle may include a relative position detection unit that is able to detect a relative position with respect to another vehicle closest to the autonomous vehicle and a relative speed detection unit that is able to detect a relative speed with respect to the other vehicle, and the warning sound may be selected based on at least one of the relative position and the relative speed.

With above configuration, the warning sound can be changed based on at least one of the relative position and the relative speed with respect to the other vehicle, whereby an effective warning can be issued to the other vehicle closest to the autonomous vehicle.

Further, the warning sound may be selected by making at least one of a change of an opening degree of a flap that is installed in the autonomous vehicle and through which a warning sound passes, a change of voltage of the warning sound output device, a change of current of the warning sound output device, a change of an opening area of a radiator grill, a change of frequency of the warning sound, a change of a position of the warning sound output device, and a change of an orientation of the warning sound output device.

With the above configuration, the warning sound can be easily changed.

With the autonomous vehicle control device according to the present disclosure, it is possible to suppress the occupants and the pedestrians from feeling anxiety when an abnormality occurs in the warning sound output device.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a schematic configuration diagram of an autonomous vehicle according to a first embodiment of the present disclosure;

FIG. 2 is a flowchart showing an example of a processing procedure for traveling prohibition control of an autonomous vehicle by an autonomous vehicle control device when a warning sound abnormality occurs;

FIG. 3 is a schematic configuration diagram of an autonomous vehicle according to a second embodiment of the present disclosure;

FIG. 4 is a schematic diagram for explaining the structure and operation of a warning sound changing device;

FIG. 5 is a flowchart showing an example of a processing procedure for warning sound selection control based on global positioning system position information and relative position and speed information with respect to another vehicle in the autonomous vehicle control device;

FIG. 6A is an example of a warning sound sounding pattern stored in a storage unit;

FIG. 6B is an example of another warning sound sounding pattern stored in the storage unit;

FIG. 6C is an example of still another warning sound sounding pattern stored in the storage unit;

FIG. 7A is a schematic view showing a process in which the autonomous vehicle overtakes and leaves the other vehicle far behind, and is a plan view when the two vehicles are viewed from the upper side in the vertical direction;

FIG. 7B is a schematic view showing a process in which the autonomous vehicle overtakes and leaves the other vehicle far behind, and is a plan view when the two vehicles are viewed from the upper side in the vertical direction;

FIG. 7C is a schematic view showing a process in which the autonomous vehicle overtakes and leaves the other vehicle far behind, and is a plan view when the two vehicles are viewed from the upper side in the vertical direction;

FIG. 7D is a schematic view showing a process in which the autonomous vehicle overtakes and leaves the other vehicle far behind, and is a plan view when the two vehicles are viewed from the upper side in the vertical direction;

FIG. 7E is a schematic view showing a process in which the autonomous vehicle overtakes and leaves the other vehicle far behind, and is a plan view when the two vehicles are viewed from the upper side in the vertical direction;

FIG. 7F is a schematic view showing a process in which the autonomous vehicle overtakes and leaves the other vehicle far behind, and is a plan view when the two vehicles are viewed from the upper side in the vertical direction;

FIG. 8A is a schematic view illustrating the relationship between a relative speed of the autonomous vehicle with respect to the other vehicle and the sound pressure of the warning sound, and is a plan view when the autonomous vehicle and the other vehicle are viewed from the upper side in the vertical direction;

FIG. 8B is a schematic view illustrating the relationship between a relative speed of the autonomous vehicle with respect to the other vehicle and the sound pressure of the warning sound, and is a plan view when the autonomous vehicle and the other vehicle are viewed from the upper side in the vertical direction;

FIG. 9 is a schematic diagram corresponding to FIG. 4 in a warning sound changing device according to a modification;

FIG. 10 is a flowchart corresponding to FIG. 5 in the autonomous vehicle provided with the warning sound changing device according to the modification;

FIG. 11 is a schematic diagram corresponding to FIG. 4 in a warning sound changing device according to another modification; and

FIG. 12 is a flowchart corresponding to FIG. 5 in the autonomous vehicle provided with the warning sound changing device according to the other modification.

### DETAILED DESCRIPTION OF EMBODIMENTS

Hereinafter, embodiments according to the present disclosure will be described in detail with reference to the accompanying drawings. It is assumed from the beginning that a new embodiment is constructed by appropriately combining the feature portions of a plurality of embodiments and modifications described below. Further, in the following description, each sensor and an autonomous vehicle control device may be connected by wire or may communicate with each other wirelessly. Further, in the following embodiments, in the drawings, the same configuration is designated by the same reference symbol and the duplicate description is omitted, and the same operation is designated by the same step number and the duplicate description is omitted. The present disclosure is not restricted to the embodiments described below and modifications thereof, and various improvements and changes can be made within the scope of the matter described in the claims of the present application and the equivalent scope thereof.

### First Embodiment

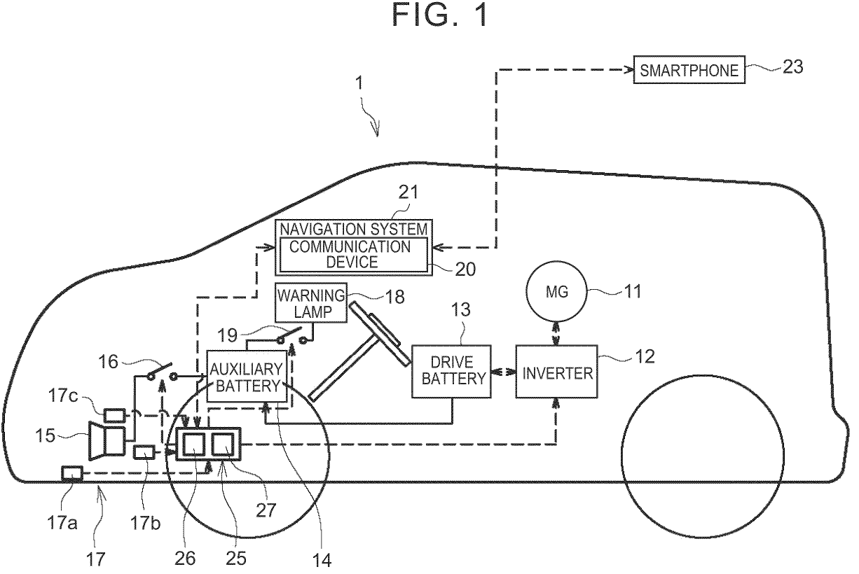

FIG. 1 is a schematic configuration diagram of an autonomous vehicle 1 according to a first embodiment of the present disclosure. Although the autonomous vehicle 1 is a battery electric vehicle (BEV) traveling by power generated by a motor generator 11, the autonomous vehicle 1 may be a hybrid electric vehicle (HEV) traveling by power generated by an engine and a motor generator, or may be a plug-in hybrid electric vehicle (PHEV).

The autonomous vehicle 1 recognizes the surrounding situation using a camera, a millimeter wave sensor (millimeter wave radar), a laser imaging detection and ranging (LIDAR) sensor, an ultrasonic sensor, a global positioning system (GPS), etc., and autonomously travels only by designating a destination. The camera is suitably used for identifying an object by applying image processing to the captured image, and is also used for identifying the color of a traffic light and a road sign in addition to other vehicles and pedestrians. Further, the millimeter wave sensor irradiates millimeter waves (wavelengths of 1 to 10 millimeters (mm) in electromagnetic waves) to the obstacle, and measures the distance to the obstacle and the direction of the obstacle based on the time from when the millimeter waves are reflected from the obstacle and returns. Further, the LIDAR sensor measures the scattered light with respect to irradiation of the laser beam emitted in a pulse shape, and detects the distance to a target at a long distance, the direction of the target, and the like. Further, the ultrasonic sensor identifies the object using high frequency ultrasonic waves, and is mainly used for detecting the object located at a short distance.

As shown in FIG. 1, the autonomous vehicle 1 includes: a motor generator 11; a drive battery 13 that is electrically connected to the motor generator 11 via an inverter 12 and is charged with electric power from the outside; an auxiliary battery 14 that is charged with electric power from the drive battery 13 and supplies electric power to electrical components driven by lower power than the motor generator 11; a warning sound output device 15 that outputs a warning sound (horn); a first switch unit 16 that is electrically connected between the auxiliary battery 14 and the warning sound output device 15; a warning sound abnormality detection unit 17 that detects a warning sound abnormality; a warning lamp 18 that calls attention to a person in the vehicle; a second switch unit 19 that is electrically connected between the auxiliary battery 14 and the warning lamp 18; a navigation system 21 on which a communication device 20 capable of communicating with the outside is mounted; and an autonomous vehicle control device 25. Each of the first and second switch units 16 and 19 includes a switching element composed of an electromagnetic relay, a transistor, or the like. On and off of each of the first and second switch units 16 and 19 is controlled based on the signal from the autonomous vehicle control device 25, and energization or de-energization is selectively realized.

The motor generator 11 is composed of, for example, a three-phase alternate current (AC) motor, and the drive battery 13 is composed of a secondary battery such as a lithium ion battery. The direct current (DC) power output by the drive battery 13 is converted into AC power by the inverter 12 and then supplied to the motor generator 11. In contrast, when the motor generator 11 generates AC power by the regenerative operation, the AC power is converted into DC power by the inverter 12, and then the drive battery 13 is charged with the converted power.

The auxiliary battery 14 is composed of, for example, a 12 V lead-acid battery, and supplies electric power to low-voltage drive electrical components such as headlights, turn signals, an audio system, and the autonomous vehicle control device 25. The warning sound output device 15 is composed of, for example, a flat horn, and includes a coil, an armature, a core, and a diaphragm. When the first switch unit 16 is controlled to turn on, the coil is energized and the core is magnetized, and as a result, the armature is attracted to the core and collides with the core. Due to this collision, the diaphragm vibrates and a warning sound is output. The warning sound output device 15 is not limited to a flat horn, and may be configured by any other horn capable of outputting a warning sound, such as a spiral horn.

The warning sound abnormality detection unit 17 includes one or more sensors capable of determining the warning sound abnormality. In the present embodiment, the warning sound abnormality detection unit 17 includes three sensors, specifically, a microphone 17a for measuring a sound pressure when the warning sound output device 15 is activated, a current-voltage sensor 17b for detecting the current flowing through the coil and the voltage of the coil, and a vibration sensor 17c for detecting vibration of the vibrating body. The warning sound abnormality detection unit 17 outputs sound pressure information detected by the microphone 17a, current and voltage information of the coil detected by the current-voltage sensor 17b, and vibration information detected by the vibration sensor 17c to the autonomous vehicle control device 25. The warning lamp 18 is installed in a vehicle cabin, for example, in an instrument panel in front of the vehicle cabin. The warning lamp 18 is turned on when the second switch unit 19 is controlled to turn on.

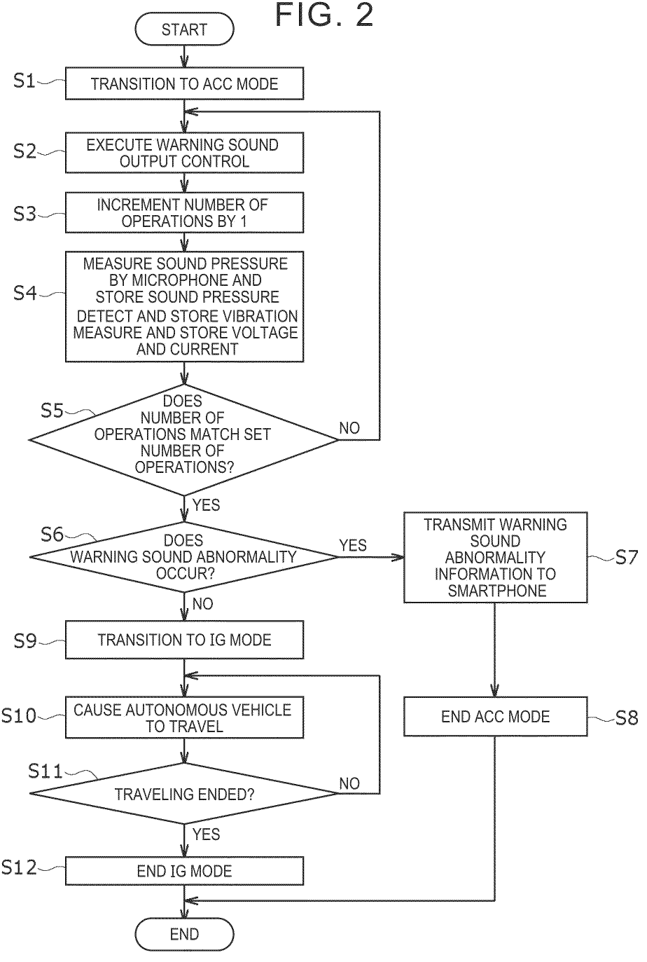

The warning lamp 18 is provided to alert a person in the vehicle that the warning sound output device 15 does not operate normally. Further, the navigation system 21 performs a known navigation operation and also performs bidirectional communication with the outside using the communication device 20. The autonomous vehicle 1 can receive a control signal from the outside by the communication device 20, and traveling is controlled based on the control signal from the outside. Further, the communication device 20 can transmit information to a predetermined information terminal 23. In the example shown in FIG. 1, the information terminal 23 is composed of a smartphone. However, the information terminal 23 may be composed of a personal computer, a workstation, a tablet, or the like. The information to be transmitted to the information terminal 23 will be described later with reference to FIG. 2.

The autonomous vehicle control device 25 receives the signal from the warning sound abnormality detection unit 17, and also receives the signal from the external information terminal 23 via the communication device 20. The autonomous vehicle 1 may have a switching operation unit that can be switched to manual driving, or may be driven by an operation by the driver.

The autonomous vehicle control device 25 is an electronic control unit, is composed of a computer, for example, a microcomputer, and includes a control unit 26 and a storage unit 27. The control unit 26, that is, a processor, includes, for example, a central processing unit (CPU). The storage unit 27 is composed of a hard disk drive (HDD), a semiconductor memory, or the like, and the semiconductor memory is composed of a non-volatile memory such as a read-only memory (ROM) or a volatile memory such as a random access memory (RAM). The storage unit 27 may be composed of only one storage medium, or may be composed of a plurality of different storage media. The non-volatile memory stores a control program, a predetermined threshold value, and the like in advance. Further, the volatile memory temporarily stores the read control program, the threshold value, the processing data, and the like. Further, the CPU performs signal processing in accordance with a program stored in advance in the ROM while using, for example, the transitory storage function of the RAM.

### Traveling Prohibition Control When Warning Sound Abnormality Occurs

The autonomous vehicle control device 25 executes control to prohibit the autonomous vehicle 1 from transitioning to the traveling mode when a warning sound abnormality occurs. FIG. 2 is a flowchart showing an example of the processing procedure for the control. With reference to FIG. 2, for example, when a signal for causing the autonomous vehicle 1 to travel is output from the information terminal 23 to the autonomous vehicle control device 25 via the communication device 20, control is started and the autonomous vehicle control device 25 causes the autonomous vehicle 1 to transition to an accessory (ACC) mode (step S1). The ACC mode is a mode in which electrical components with low power consumption, for example, a navigation system, an audio device, an electronic toll collection system (ETC), and the like can be used. In the ACC mode, it is possible to use first electric power with which the autonomous vehicle 1 cannot travel, whereas it is impossible to use second electric power with which the autonomous vehicle 1 can travel.

Subsequently, the autonomous vehicle control device 25 controls the first switch unit 16 to turn on in the ACC mode to cause the warning sound output device 15 to output the warning sound (step S2), and the control unit 26 increments the number of operations stored in the storage unit 27 by one (step S3). Subsequently, for the output warning sound, the microphone 17a of the warning sound abnormality detection unit 17 detects the sound pressure, the current-voltage sensor 17b detects the current and voltage of the coil, the vibration sensor 17c detects the vibration, and the storage unit 27 stores information on the sound pressure, the current and voltage, and the vibration (step S4).

Subsequently, in step S5, the autonomous vehicle control device 25 determines whether the number of operations matches at the set number of operations that is predetermined. The set number of operations may be set to any number of 1 or more. When a negative determination is made in step S5, step S2 and subsequent steps are repeated. On the other hand, when an affirmative determination is made in step S5, the autonomous vehicle control device 25 determines whether a warning sound abnormality occurs (step S6). The determination above is made in a manner such that the autonomous vehicle control device 25 compares information on a sound pressure range of the normal warning sound, a current-voltage range, and a vibration range stored in the storage unit 27 in advance with information on the sound pressure of the warning sound, the current and voltage, and the vibration measured in each measurement.

In the present embodiment, when any one of the three types of physical information detected by the three sensors 17a, 17b, 17c deviates from the normal range at in any of measurements, the autonomous vehicle control device 25 determines that a warning sound abnormality occurs. Setting such a strict determination condition makes it possible to reliably detect a warning sound abnormality and improve the operability. The warning sound abnormality detection unit may be provided with a plurality of sensors capable of determining a warning sound abnormality, and detect the warning sound abnormality when the multiple sensors determine that the warning sound abnormality occurs. In this case, it is possible to accurately determine whether the warning sound abnormality occurs.

When a negative determination is made in step S6, the mode transitions to an ignition (IG) mode that is the traveling mode (step S9), and traveling of the autonomous vehicle 1 is started (step S10). The IG mode is a mode in which the second electric power that is larger than the first electric power that can be used in the ACC mode and enables the autonomous vehicle 1 to travel can be used, and a mode in which the drive battery 13 can be used. The transition to the IG mode is performed, for example, when the autonomous vehicle control device 25 controls the main relay (not shown) connected between the inverter 12 and the motor generator 11 to turn on. Further, the autonomous vehicle 1 can travel by supplying electric power from the drive battery 13 to the motor generator 11 when the autonomous vehicle control device 25 controls the inverter 12.

After that, the autonomous vehicle control device 25 determines whether to end traveling of the autonomous vehicle 1 (step S11). This determination is performed, for example, in a manner such that the autonomous vehicle control device 25 determines whether the traveling operation stored in the storage unit 27 in advance is completed, for example. When a negative determination is made in step S11, the process returns to step S10, and traveling of the autonomous vehicle 1 is continued. On the other hand, when an affirmative determination is made in step S11, the IG mode ends (step S12), and the control ends.

On the other hand, when an affirmative determination is made in step S6, the process proceeds to step S7, and the autonomous vehicle control device 25 causes the communication device 20 to transmit the information indicating that the warning sound abnormality occurs to the predetermined information terminal 23, in the present embodiment, a smartphone of the owner of the autonomous vehicle 1 (step S7). Then, the ACC mode ends (step S8) and the control ends. That is, when the warning sound abnormality is detected in step S6, the transition from the ACC mode to the IG mode that enables traveling is prohibited, and traveling of the autonomous vehicle 1 is thus prohibited, thereby disabling traveling of the autonomous vehicle 1.

According to the first embodiment, when an abnormality occurs in the warning sound output device 15, transition to the traveling mode is disabled, whereby traveling of the autonomous vehicle 1 can be prohibited. Therefore, it is possible to eliminate anxiety of the occupants of the autonomous vehicle 1 and the pedestrians.

Further, before traveling, the warning sound abnormality detection unit 17 detects output of the warning sound output by the warning sound output device 15, and determines whether a warning sound abnormality occurs based on the output data of the warning sound. Therefore, the warning sound abnormality can be accurately determined.

Further, when a warning sound abnormality occurs, the communication device 20 transmits a signal indicating the abnormality to the predetermined information terminal 23. Therefore, a predetermined person, for example, the owner of the autonomous vehicle 1, etc. can be notified of the abnormality in the warning sound output device 15 promptly, which enables immediate repair of the warning sound output device 15. Exceptions to Traveling Prohibition Control

Information that realizes an allowable mode that allows the transition to the traveling mode only once may be stored in the storage unit 27. Then, in the case where the communication device 20 transmits the signal indicating a warning sound abnormality to the predetermined information terminal 23 when the abnormality occurs, after the signal is transmitted, the autonomous vehicle control device 25 realizes the allowable mode and allows transition to the traveling mode only once upon receipt of a signal enabling the above allowable mode from the information terminal 23 via the communication device 20. Further, position information of a predetermined location to which the autonomous vehicle 1 moves in the traveling mode when the allowable mode is enabled and the transition to the traveling mode is allowed only once may be stored in the storage unit 27 in advance. The predetermined location may be a repair shop of the autonomous vehicle 1.

With the above, for example, the autonomous vehicle 1 can travel to the repair shop only by a person who can access the information terminal 23 that has received the warning sound abnormality information from the communication device 20, for example, the owner of the autonomous vehicle 1, etc. outputting the signal enabling the allowable mode from the information terminal 23 to the autonomous vehicle control device 25 via the communication device 20. Therefore, the autonomous vehicle 1 can be easily and smoothly brought to the repair shop.

Further, in that case, when the transition to the traveling mode is exceptionally allowed, the autonomous vehicle 1 may perform any one of traveling with the warning lamp 18 turned on and traveling of the autonomous vehicle 1 at a predetermined vehicle speed or less. Here, turning on of the warning lamp 18 is performed as the autonomous vehicle control device 25 controls the second switch unit 19 to turn on, and traveling of the autonomous vehicle 1 at the predetermined vehicle speed or less is performed as the autonomous vehicle control device 25 controls the inverter 12. With this configuration, even when the warning sound output device 15 does not operate normally, it is possible to realize at least one of capability to alert people in the vehicle and easiness to cause the autonomous vehicle 1 to safely travel to the repair shop.

In the case where sound output control for outputting the warning sound to the warning sound output device 15 is executed in the ACC mode and whether the warning sound abnormality occurs is determined based on the output data of the warning sound output by the warning sound output device 15 has been described. However, whether the warning sound abnormality occurs may be determined based on the warning sound output by the warning sound output device 15 while the autonomous vehicle 1 is traveling. Then, when the autonomous vehicle control device 25 determines that an abnormality occurs based on the warning sound during traveling, transition to the traveling mode may be prohibited after the traveling mode in which the abnormality is determined ends, or transition to the traveling mode in the above configuration may be allowed only once exceptionally. Note that, the autonomous vehicle control device 25 determines that the warning sound abnormality occurs during traveling based on an output signal from the warning sound abnormality detection unit 17.

### Second Embodiment

The laws and regulations based on which the warning sounds can be output differ depending on the country or region where the autonomous vehicle is located. Further, the sound that a person can recognize as a warning sound differs depending on the country or region. Still further, when the warning sound is transmitted to another vehicle, appropriate warning can be issued to the other vehicle by selecting the warning sound based on a relative speed and a relative position with respect to the other vehicle. In the second embodiment, the autonomous vehicle control device that causes the warning sound output device to output an appropriate warning sound in such a situation after the autonomous vehicle transitions to the traveling mode will be described.

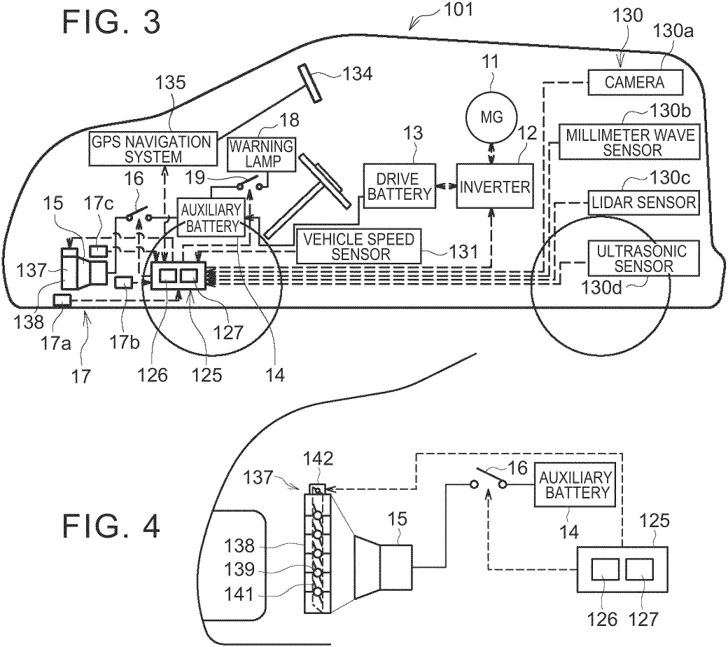

FIG. 3 is a schematic configuration diagram of an autonomous vehicle 101 according to a second embodiment of the present disclosure. As shown in FIG. 3, the autonomous vehicle 101 includes a relative speed and position detection unit 130 for detecting a relative speed and a relative position with respect to another vehicle, a vehicle speed sensor 131 that detects a vehicle speed, a GPS navigation system 135 provided with a GPS receiver including a GPS antenna 134 that receives GPS signals (microwaves superimposed with time information and orbit information) transmitted by artificial satellites (GPS satellites) that travel along an orbit over the earth, and a warning sound changing device 137 that changes the warning sound to be output by the warning sound output device 15. The relative speed and position detection unit 130 includes, for example, one or more of the above-mentioned sensors necessary for autonomous driving, such as a camera 130a, a millimeter wave sensor 130b, a LIDAR sensor 130c, and an ultrasonic sensor 130d.

FIG. 4 is a schematic diagram for explaining the structure and operation of the warning sound changing device 137. As shown in FIG. 4, the warning sound changing device 137 includes a flap mechanism 138 installed at an opening of the warning sound output device 15. The flap mechanism 138 includes one or more rotating shafts 139, a flap 141 externally fitted and fixed to each rotating shaft 139, and an actuator (composed of a motor or the like) 142 that rotates each rotating shaft 139, for example, rotates all of the rotating shafts 139 simultaneously in the same direction and at the same angle. When the autonomous vehicle control device 125 controls an operation of the actuator 142 to change an opening area of the opening closed by one or more flaps 141 and change an inclination angle of each flap 141 with respect to the opening, thereby changing the warning sound output by the warning sound output device 15.

### Warning Sound Selection Control Based on GPS Position Information and Relative Position and Speed Information with Respect to Another Vehicle

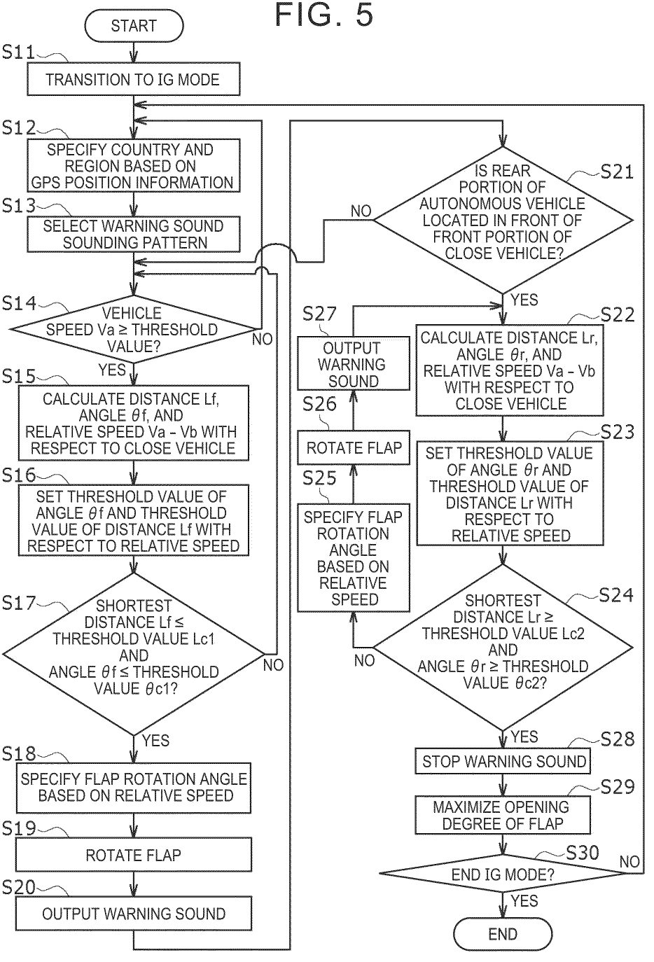

FIG. 5 is a flowchart showing an example of a processing procedure of warning sound selection control based on GPS position information and relative position and speed information with respect to another vehicle. With reference to FIG. 5, when there is no abnormality in the warning sound output device 15, the control is started, the mode transitions to the IG mode that is the traveling mode (step S11), and the country or region where the autonomous vehicle 101 is located is specified based on the GPS position information (step S12). Subsequently, in step S13, the autonomous vehicle control device 125 selects a warning sound sounding pattern. The storage unit 127 of the autonomous vehicle control device 125 stores the country or region specified by GPS in association with the warning sound sounding pattern. The warning sound sounding pattern is selected by the control unit 126 of the autonomous vehicle control device 125 based on the GPS position information and the storage information of the storage unit 127.

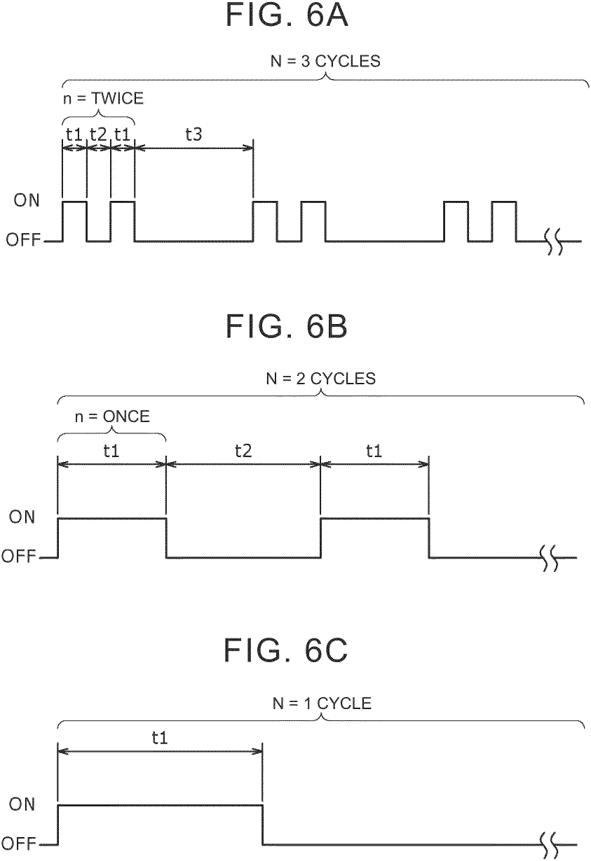

FIGS. 6A to 6B are examples of the warning sound sounding patterns stored in the storage unit 127. In the warning sound sounding pattern shown in FIG. 6A, the warning sound is sounded for three cycles, and sounding of the warning sound in each cycle is performed such that the warning sound that continues for time t1 twice at an interval of time t2. Further, the interval between cycles is set to time t3.

In the warning sound sounding pattern shown in FIG. 6B, the warning sound is sounded for two cycles, and sounding of the warning sound in each cycle is performed such that the warning sound that continues for the time t1 once. Further, the interval between cycles is set to the time t2. Further, in the warning sound sounding pattern shown in FIG. 6C, the warning sound is sounded once, and the warning sound continues for the time t1. Each warning sound sounding pattern is determined to conform to the customs of the corresponding country or region. Therefore, it is possible to sound an appropriate warning sound based on the country or region where the autonomous vehicle 1 is located.

Note that, the autonomous vehicle control device 125 includes a timer and a counter for adjusting the number of times the warning sound of the warning sound output device 15 is sounded and the interval between resonances. In the warning sound sounding patterns shown in FIGS. 6A to 6C, the number of cycles and the number of warning sounds in each cycle are controlled by the counter, and each time is controlled by the timer.

In step S14 after step S13, the autonomous vehicle control device 125 determines whether a vehicle speed Va of the autonomous vehicle 101 is larger than a threshold value based on the information from the vehicle speed sensor 131. Step S14 is executed to determine whether the autonomous vehicle 101 is traveling. When a negative determination is made in step S14, step S12 and subsequent steps are repeated.

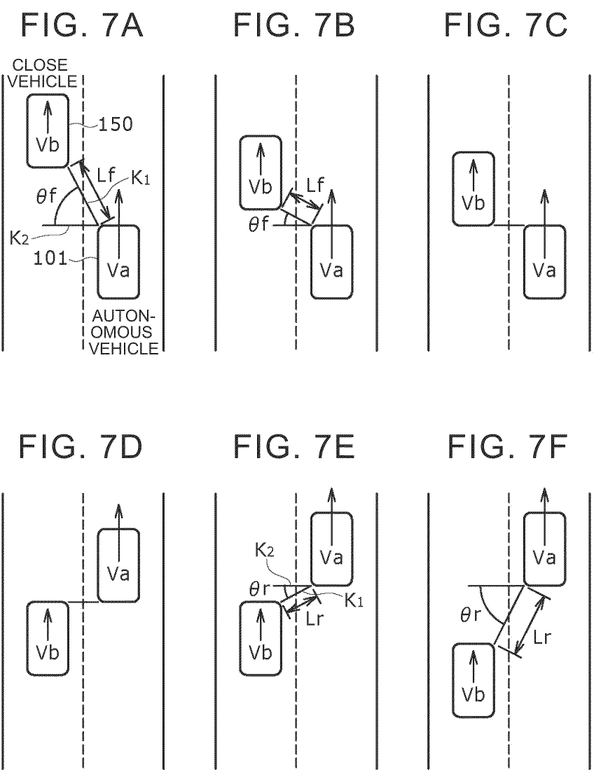

On the other hand, when an affirmative determination is made in step S14, the autonomous vehicle control device 125 calculates a shortest distance Lf and an angle θf with another vehicle 150 closest to the autonomous vehicle 101 as shown in FIG. 7A, and a relative speed (Va - Vb) of the autonomous vehicle 101 with respect to the other vehicle 150, based on the information from the camera 130a, the millimeter wave sensor 130b, the LIDAR sensor 130c, and the ultrasonic sensor 130d (step S15).

With reference to FIG. 7A, the shortest distance Lf is the shortest distance between the autonomous vehicle 101 and the other vehicle 150 in the case where the other vehicle 150 closest to the autonomous vehicle 101 is located in front of the autonomous vehicle 101 in plan view viewed from above in the vertical direction. Further, the angle θf (0 ≤ θf < 90°) is an angle formed by a line k1 that realizes the above-mentioned shortest distance above when the other vehicle 150 is located in front of the autonomous vehicle 101 in the plan view above and a width direction k2 of the autonomous vehicle 101. Further, Va is the speed of the autonomous vehicle 101, and Vb is the speed of the other vehicle 150. The autonomous vehicle control device 125 calculates the relative speed (Va - Vb) based on the amount of change in the shortest distance Lf per unit time and the amount of change in the angle θf per unit time.

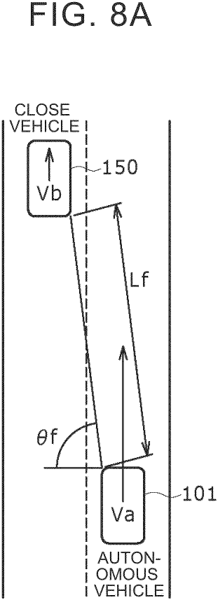

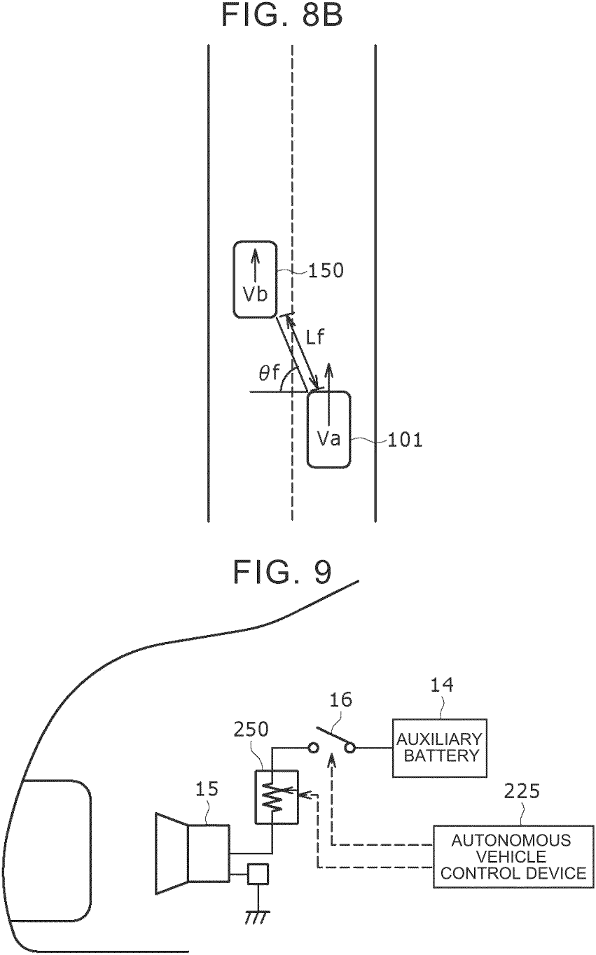

In step S16, the autonomous vehicle control device 125 determines a threshold angle θc1 with respect to the angle θf and a threshold distance Lc1 with respect to the shortest distance Lf based on the relative speed (Va - Vb). The relative speed (Va - Vb), the threshold angle θc1, and the threshold distance Lc1 are stored in the storage unit 127 of the autonomous vehicle control device 125 in association with each other. As the relative speed (Va - Vb) increases, the threshold angle θc1 and the threshold distance Lc1 increase continuously or stepwise. The reason for the above will be explained later with reference to FIGS. 8A and 8B.

In step S17, whether the autonomous vehicle control device 125 determines whether the shortest distance Lf≤ the threshold distance Lc1 and the angle θf≤ the threshold angle θc1 are satisfied. When a negative determination is made in step S17, step S14 and subsequent steps are repeated. On the other hand, when an affirmative determination is made in step S17, in step S18, the autonomous vehicle control device 125 specifies an opening degree of the opening of the warning sound output device 15, that is, a rotation angle of the flap 141, based on the relative speed (Va - Vb).

As will be described later with reference to FIGS. 8A and 8B, when the relative speed (Va - Vb) is known, the sound pressure of the warning sound effective for warning can be specified. Further, the sound pressure of the warning sound corresponds to the opening degree of the opening of the warning sound output device 15 on a one-to-one basis. The storage unit 127 of the autonomous vehicle control device 125 stores the relative speed (Va - Vb) and the opening degree of the opening of the warning sound output device 15, that is, the rotation angle of the flap 141, in association with each other. The autonomous vehicle control device 125 determines the rotation angle of the flap 141 based on the relative speed (Va - Vb) with reference to this stored data.

Subsequently, the autonomous vehicle control device 125 controls the actuator 142 to rotate the flap 141 by the rotation angle specified in step S18 (step S19), and causes the warning sound output device 15 to output a warning sound (step S20).

In step S21, the autonomous vehicle control device 125 determines whether the rear end of the autonomous vehicle 101 is located on the front side of the front end of the other vehicle 150. When a negative determination is made in step S21, step S14 and subsequent steps are repeated. On the other hand, when an affirmative determination is made in step S21, the autonomous vehicle control device 125 calculates a shortest distance Lr and an angle θr with respect to the other vehicle 150 as shown in FIG. 7E, and a relative speed (Va - Vb) of the autonomous vehicle 101 with respect to the other vehicle 150, based on the information from the camera 130a, the millimeter wave sensor 130b, the LIDAR sensor 130c, and the ultrasonic sensor 130d (step S22).

With reference to FIG. 7E, the shortest distance Lr is the shortest distance between the autonomous vehicle 101 and the other vehicle 150 in the case where the other vehicle 150 is located at the rear of the autonomous vehicle 101 in plan view viewed from above in the vertical direction. Further, the angle θr (0 < θr < 90°) is formed by the line k1 that realizes the shortest distance when the other vehicle 150 is located at the rear of the autonomous vehicle 101 in the plan view above and a width direction k2 of the autonomous vehicle 101. The autonomous vehicle control device 125 calculates the relative speed (Va -Vb) based on the amount of change in the shortest distance Lr per unit time and the amount of change in the angle θr per unit time.

In step S23, the autonomous vehicle control device 125 determines a threshold angle θc2 with respect to the angle θr and a threshold distance Lc2 with respect to the shortest distance Lr based on the relative speed (Va - Vb). The relative speed (Va - Vb), the threshold angle θc2, and the threshold distance Lc2 are stored in the storage unit 127 of the autonomous vehicle control device 125 in association with each other. As the relative speed (Va - Vb) increases, the threshold angle θc2 and the threshold distance Lc2 increase continuously or stepwise. The threshold distance Lc2 may be the same as or different from the threshold distance Lc1. Further, the threshold angle θc2 may be the same as or different from the threshold angle θc1.

In step S24, whether the autonomous vehicle control device 125 determines whether the shortest distance Lr ≥ the threshold distance Lc2 and the angle θr≥ the threshold angle θc2 are satisfied. When a negative determination is made in step S24, the autonomous vehicle control device 125 specifies the opening degree of the opening of the warning sound output device 15, that is, the rotation angle of the flap 141, based on the relative speed (Va - Vb) (step S25), rotates the flap 141 by the rotation angle specified in step S25 (step S26), and causes the warning sound output device 15 to output a warning sound (step S27), and then step S22 and subsequent steps are repeated.

On the other hand, when an affirmative determination is made in step S24, the autonomous vehicle control device 125 causes the warning sound output device 15 to stop outputting the warning sound (step S28), returns the position of the flap 141 to the position where the opening degree of the opening of the warning sound output device 15 is maximized (step S29), and determines whether to end the IG mode (step S30). When a negative determination is made in step S30, steps S12 and subsequent steps are repeated, and when an affirmative determination is made in step S30, the control ends.

FIGS. 7A to 7F are schematic views showing a process in which the autonomous vehicle 101 overtakes and leaves the other vehicle 150 far behind, and are plan views when the two vehicles 101, 150 are viewed from the upper side in the vertical direction. The relative positions of the two vehicles 101, 150 transition from FIG. 7A to FIG. 7F as time passes. As shown in FIGS. 7A and 7B, as the autonomous vehicle 101 approaches the other vehicle 150 from behind, the angle θf gradually decreases, and the shortest distance Lf also gradually decreases. Then, as shown in FIG. 7C, when the front end of the autonomous vehicle 101 is aligned with the rear end of the other vehicle 150, the angle θf becomes 0. After that, as shown in FIG. 7D, the rear end of the autonomous vehicle 101 is aligned with the front end of the other vehicle 150, and as shown in FIGS. 7E and 7F, the angle θr gradually increases and the shortest distance Lr also gradually increases as the autonomous vehicle 101 leaves the other vehicle 150 far behind.

The warning sound is sounded from the state where the shortest distance Lf ≤ the threshold distance Lc1 and the angle θf≤ the threshold angle θc1 are satisfied until the shortest distance Lr ≥ the threshold distance Lc2 and the angle θr ≥ the threshold angle θc2 are satisfied. Further, the sound pressure of the warning sound to be sounded is selected based on the relative speed (Va - Vb).

FIGS. 8A and 8B are schematic views illustrating the relationship between the relative speed (Va - Vb) of the autonomous vehicle 101 with respect to the other vehicle 150 and the sound pressure of the warning sound, and are plan views when the autonomous vehicle 101 and the other vehicle 150 are viewed from the upper side in the vertical direction. With reference to FIG. 8A, when the relative speed (Va - Vb) is large, the autonomous vehicle 101 approaches the other vehicle 150 in a short time. Therefore, the autonomous vehicle 101 outputs a warning sound from a position far from the other vehicle 150. Therefore, it is easy for the other vehicle 150 to hear the warning sound when the sound pressure is large because the warning sound is output from the position far from the other vehicle 150. Therefore, the sound pressure is set large. Further, when the relative speed (Va - Vb) is large, the autonomous vehicle 101 approaches the other vehicle 150 in a short time. Therefore, the threshold distance Lc1 is set long and the threshold angle θc1 is set large.

On the other hand, with reference to FIG. 8B, when the relative speed (Va - Vb) is small, the autonomous vehicle 101 approaches the other vehicle 150 in a long time. Therefore, the autonomous vehicle 101 outputs a warning sound from a position close to the other vehicle 150. Therefore, it is easy for the other vehicle 150 to hear the warning sound even when the sound pressure is small because the warning sound is output from the position close to the other vehicle 150. Therefore, the sound pressure is set small. Further, when the relative speed (Va - Vb) is small, the autonomous vehicle 101 approaches the other vehicle 150 in a long time. Therefore, the threshold distance Lc1 is set short and the threshold angle θc1 is set small.

According to the second embodiment, the warning sound can be automatically changed so as to comply with the laws and regulations of the country or region where the autonomous vehicle 101 is located. Therefore, it is not necessary to artificially change the warning sound, and therefore the autonomous vehicle 101 can be used all over the world, whereby the autonomous vehicle 101 having excellent versatility and convenience can be realized.

In addition, it is possible to output the warning sound that is suitable for the customs of the country or region where the autonomous vehicle 101 is located, and no matter which country or region the autonomous vehicle 101 is used in, the autonomous vehicle 101 can output a sound that is easy for people in that country or region to recognize as a warning sound.

Further, the warning sound can be changed based on the relative speed with respect to the other vehicle 150. Therefore, an effective warning can be issued to the other vehicle 150. Further, the warning sound can be easily changed only by changing the opening degree of the flap 141 installed in the autonomous vehicle 101.

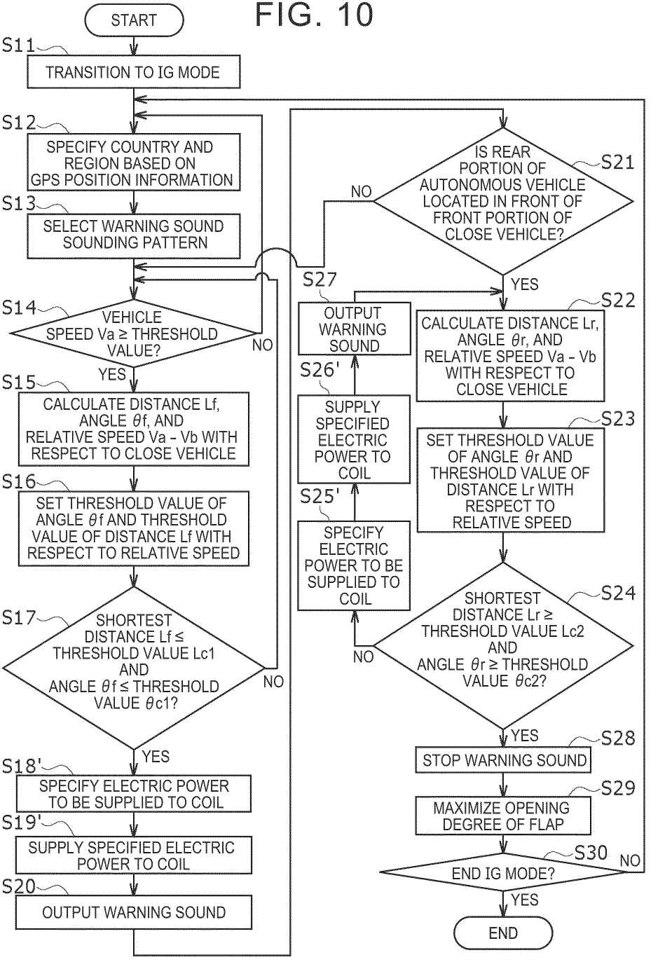

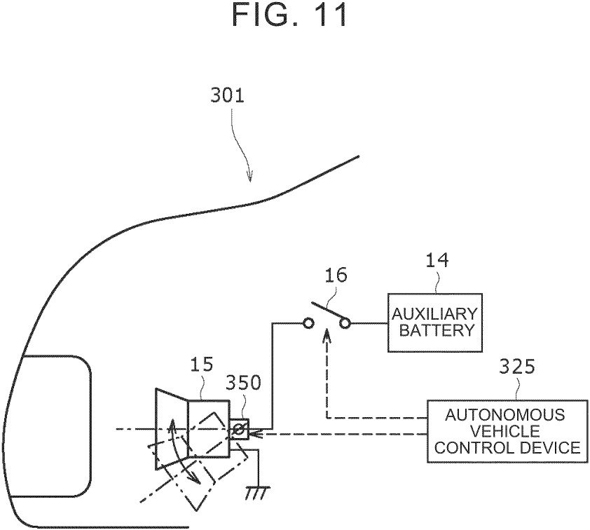

The sound pressure of the warning sound is changed by adjusting the opening degree of the flap 141 of the flap mechanism 138 installed at the opening of the warning sound output device 15. However, as shown in FIG. 9, a current-voltage adjusting device 250 capable of varying an internal resistance may be electrically connected to the warning sound output device 15. Then, as shown in FIG. 10, in steps S18' and S25', the current to flow through the coil and the voltage of the coil may be specified, and in steps S19' and S26', an autonomous vehicle control device 225 may control the current-voltage adjusting device 250 such that the current specified as above flows through the coil of the warning sound output device 15 so as to match the voltage of the coil with the voltage specified as above.

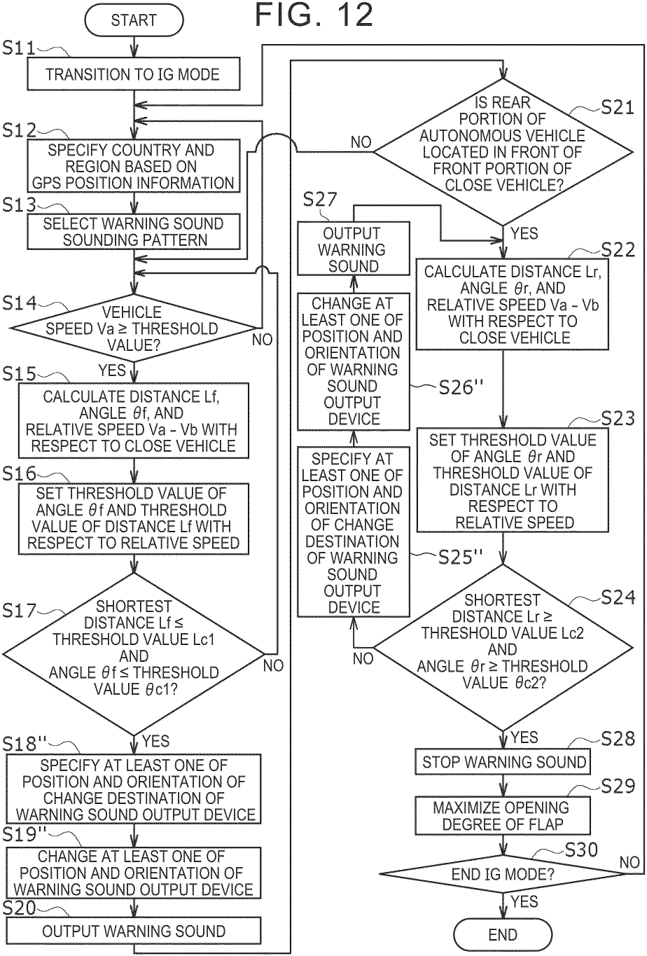

Further, as shown in FIG. 11, an actuator 350 that changes at least one of the position and the orientation of the warning sound output device 15 may be installed in an autonomous vehicle 301. Further, the actuator 350 may include at least one of a linear actuator and a motor. Then, as shown in FIG. 12, in steps S18" and S25", at least one of the position and the orientation of a change destination of the warning sound output device 15 may be specified, and in steps S19" and S26", an autonomous vehicle control device 325 may control the actuator 350 such that at least one of the position and the orientation of the warning sound output device 15 is changed to at least one of the position and the orientation specified in steps S18" and S25".

Alternatively, the autonomous vehicle control device may vary the opening degree of a movable flap that varies the opening area of a radiator grill of the autonomous vehicle so as to change the sound pressure of the warning sound, or a frequency of AC voltage that flows through the coil of the warning sound output device 15 may be changed so as to change the sound pressure of the warning sound.

Further, the case where the autonomous vehicle control device 125 changes the sound pressure of the warning sound based on the relative speed (Va - Vb) of the autonomous vehicle 101 with respect to the other vehicle 150 closest to the autonomous vehicle 101 has been described. However, the autonomous vehicle control device may change the sound pressure of the warning sound based on the relative position of the autonomous vehicle with respect to the other vehicle closest to the autonomous vehicle. Alternatively, the autonomous vehicle control device may change the sound pressure of the warning sound based on both of the relative speed and the relative position of the autonomous vehicle with respect to the other vehicle closest to the autonomous vehicle.

What is claimed is:

1. An autonomous vehicle control device that controls an autonomous vehicle provided with a warning sound output device, wherein when an abnormality occurs in the warning sound output device, transition to a traveling mode is prohibited.

2. The autonomous vehicle control device according to claim 1, wherein before traveling, sound output control to cause the warning sound output device to output a warning sound is executed, and whether the abnormality occurs is determined based on output data of the warning sound output by the warning sound output device.

3. The autonomous vehicle control device according to claim 1, wherein:
the autonomous vehicle includes a communication device for performing bidirectional wireless communication with an outside; and
when the abnormality occurs, the communication device is caused to transmit a signal indicating the abnormality to a predetermined information terminal.

4. The autonomous vehicle control device according to claim 3, comprising a storage unit that stores information that realizes an allowable mode that allows the transition to the traveling mode only once, wherein after the signal is transmitted, when a signal for enabling the allowable mode is received from the information terminal via the communication device, the transition to the traveling mode is allowed only once.

5. The autonomous vehicle control device according to claim 4, wherein when the transition to the traveling mode is allowed, at least one of traveling with a warning lamp turned on and traveling at a predetermined vehicle speed or less is executed.

6. The autonomous vehicle control device according to claim 1, wherein the warning sound is selected based on a position of the autonomous vehicle specified using a global positioning system.

7. The autonomous vehicle control device according to claim 1, wherein:
the autonomous vehicle includes a relative position detection unit that is able to detect a relative position with respect to another vehicle closest to the autonomous vehicle and a relative speed detection unit that is able to detect a relative speed with respect to the other vehicle; and
the warning sound is selected based on at least one of the relative position and the relative speed.

8. The autonomous vehicle control device according to claim 6, wherein the warning sound is selected by making at least one of a change of an opening degree of a flap that is installed in the autonomous vehicle and through which a warning sound passes, a change of voltage of the warning sound output device, a change of current of the warning sound output device, a change of an opening area of a radiator grill, a change of frequency of the warning sound, a change of a position of the warning sound output device, and a change of an orientation of the warning sound output device.
